(19) United States
(12) Patent Application Publication
(10) Pub. No.: US 2010/0198909 A1
(43) Pub. Date: Aug. 5, 2010

(54) METHOD AND APPARATUS FOR THE CONTINUOUS COLLECTION AND CORRELATION OF APPLICATION TRANSACTIONS ACROSS ALL TIERS OF AN N-TIER APPLICATION

(75) Inventors: Bruce Kosbab, Colorado Springs, CO (US); Dan Prescott, Colorado Springs, CO (US)

Correspondence Address: PATENTTM.US, P. O. BOX 82788, PORTLAND, OR, 97282-0788, US

(73) Assignee: FLUKE CORPORATION, Everett, WA (US)

(21) Appl. No.: 12/398,961

(22) Filed: Mar. 5, 2009

Related U.S. Application Data
(60) Provisional application No. 61/149,656, filed on Feb. 3, 2009.

(51) Int. Cl. G06F 15/16

(52) U.S. Cl. 709/203; 709/224

(57) ABSTRACT

Method and apparatus for continuous collection and correlation of application transactions across multiple tiers of an N-tier application employs an application monitoring appliance that observes application data and stores transactions and statistics. A reporting server aggregates and correlates monitored data from the application monitoring appliance and provides access via a web browser for viewing by a network engineer.

### CROSS REFERENCE TO RELATED APPLICATIONS

This application claims priority of U.S. provisional patent application 61/149,656, filed Feb. 3, 2009.

### BACKGROUND OF THE INVENTION

This invention relates to networking, and more particularly to method and apparatus of the monitoring and analysis of network traffic.

With reference to FIG. 1, in computer networks, an N-tier architecture is an application architecture in which different computing functionality is distributed among two or more separate computers in a distributed network.

There may be multiple computers in each tier of the architecture. N implies any number such as 2-tier or 3-tier. An N-tier architecture could comprise any number of tiers.

The most commonly used N-tier architecture is for a 3-tier application where a user's computer provides the user-interface, an application server provides the business logic, and a database server provides data storage. 4-tier architectures are also quite common. A 4-tier application is similar to the 3-tier application with the addition of a web server which provides load balancing and security functionality.

In the configuration of FIG. 1, plural remote user blocks 12 are connected to a wide area network WAN 14, through router 16, firewall 18, load balancer 20 and switch 22, which may interface with multiple web servers 24. A firewall 26 and switch 28 provide interface between the web servers and application servers 30. Switch 32 interfaces between application servers 30 and database servers 34.

When a user accesses the front tier of an n-tier application several application transactions occur. One or more transactions could occur between each tier. See FIG. 2.

In FIG. 2, an example diagram of an N-tier application transaction flow, a user is submitting a payment, represented by block 36. HTTPS Request 38 is submitted to web server 24′, which submits an HTTP Request 40 to application server 30′. An SQL (Structured Query Language) exchange takes place between the server 30′ and an account information database 32′ maintained in a database server to update account information 44 and to update an audit log 46. SQL exchange 48 between a database server and the application server returns information, which results in HTTP Response 50 from the application server 30′ to the web server 24′, and the web server communicates via HTTPS Response 52 to indicate payment received 54 to the user.

Each component (or tier) which comprises an n-tier application communicates with other tiers by using a variety of protocols. When application performance and application content problems occur it is difficult to determine the cause of the problem because any component in the transaction chain may be the cause of the problem.

Using traditional protocol analysis to troubleshoot problems in an n-tier environment is difficult, if not impossible, due to the large number of transactions that occur simultaneously between the tiers.

### SUMMARY OF THE INVENTION

In accordance with the invention, one or more application monitoring appliances observe application data across multiple tiers and determine performance statistics at certain time intervals and stores transaction data. A reporting server aggregates and correlates monitored data from one or more application monitoring appliances.

In accordance with the invention, improved measurement and analysis of network traffic is enabled.

Accordingly, it is an object of the present invention to provide an improved system and method of network analysis.

It is a further object of the present invention to provide an improved network monitoring device for enabling enhanced troubleshooting of n-tier architectures.

It is yet another object of the present invention to provide improved methods of network monitoring and analysis on n-tier architectures.

Another object of the invention is to provide an improved method and apparatus for performing analysis of n-tier network traffic.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of a typical n-tier application;

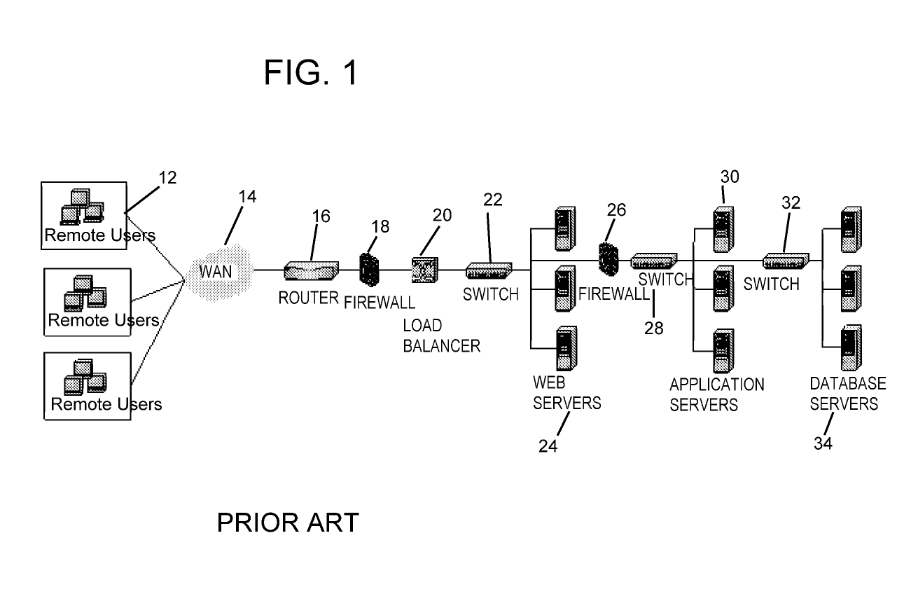

FIG. 2 is an example diagram of an N-tier application transaction flow.

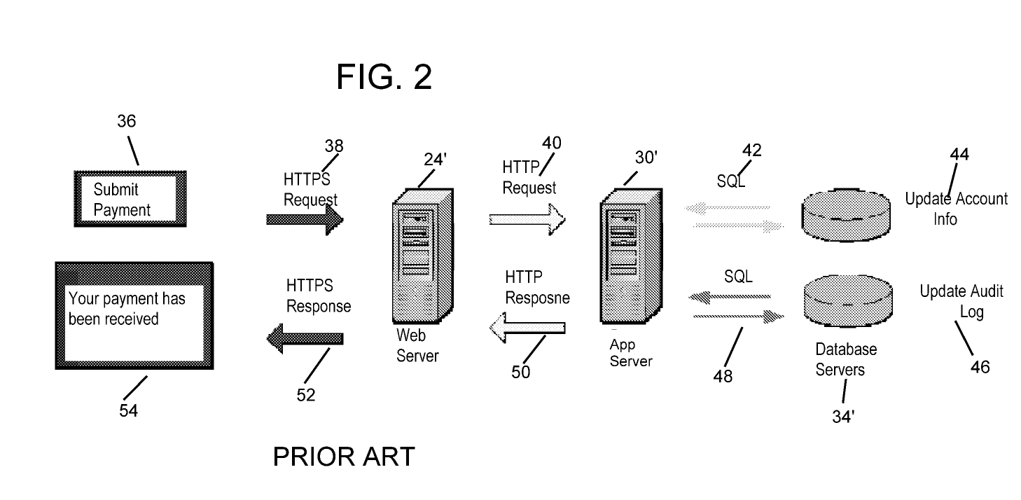

FIG. 3 is a diagram of application monitoring architecture in accordance with the invention;

FIG. 4 is an example transaction list.

### DETAILED DESCRIPTION

The system according to a preferred embodiment of the present invention comprises a method and apparatus for passively monitoring network communication between application components.

An Application Analysis Engine analyzes the communication to identify application transactions. Several pieces of information and statistics are recorded for each transaction including the time at which the transaction occurred, the application, protocol used, client IP address, server IP address, response time, number of bytes, number of packets, and many more. This information is stored in a database so that it can later be viewed by a network engineer. The network engineer can view the transactions in a time-sorted list and also the transaction details to troubleshoot applications problems across all tiers of the n-tier architecture.

The invention comprises a system that is capable of identifying and recording application transactions between each tier of an N-tier application.

This invention solves the troubleshooting problem by recording the application transactions between all of the tiers continuously and then storing those transactions in persistent storage so that they can viewed together in a time-correlated manner

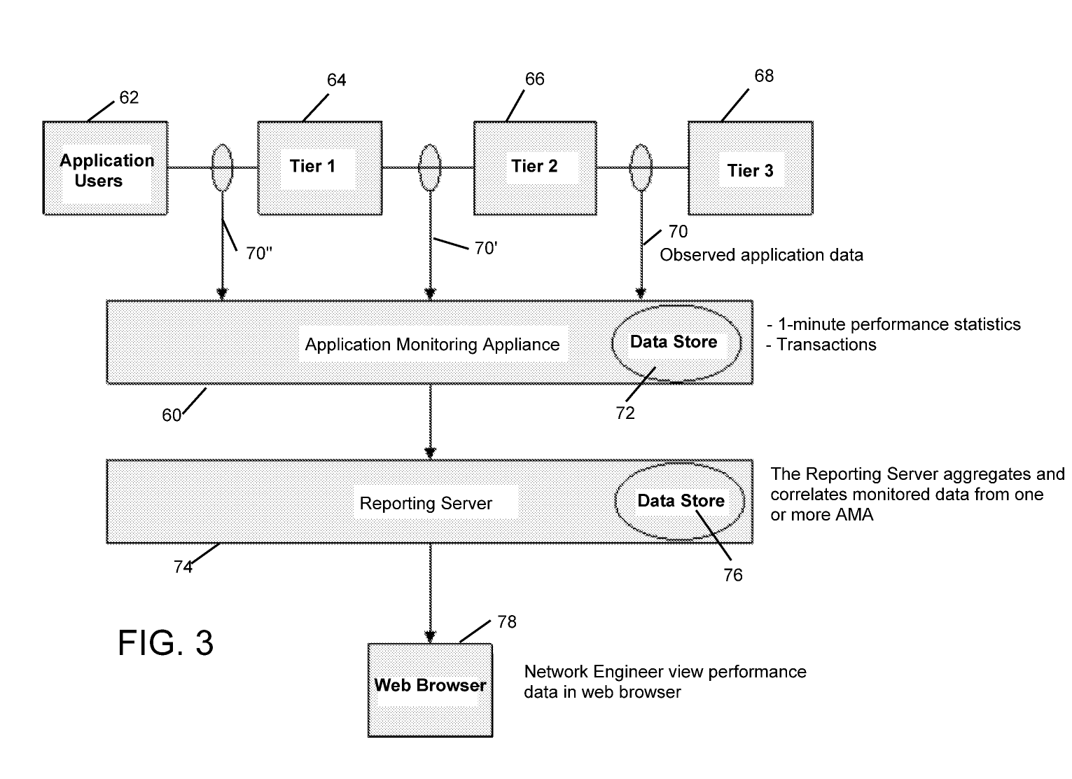

In accordance with the invention, referring to FIG. 3, a diagram of an application monitoring system deployment architecture in a 3 tier system, for example, an application monitoring appliance 60 monitors traffic between application users 62 and Tier 1, traffic between Tier 1 (64) and Tier 2 (66) and traffic between Tier 2 (66) and Tier 3 (68). In the illustrated example the traffic is observed application data 70, 70′, 70″. The application monitoring appliance includes a data store 72 which in the illustrated embodiment, includes 1-minute performance statistics (statistics calculated at 1-minute intervals) and transactions data.

Application transactions that are transmitted between the tiers of an n-tier application are observed by the Application Monitoring Appliance 60 (AMA). The AMA 60 continuously monitors application transactions and stores performance statistics and transactions in persistent data store 72 on the AMA 60, which may comprise a hard disk or other suitable storage. Application transactions that occur between the tiers are stored simultaneously.

When the stored transactions have consumed the available storage capacity the oldest transactions are removed in a first-in-first-out manner. The number of transactions which can be stored is dependent on the size of the data store 72 hard disk in the AMA 60. Millions of transactions can be stored which is typically equivalent to several days of application activity.

The application monitoring appliance provides data to a reporting server 74 (which also includes a data store 76), the reporting server aggregating and correlating monitored data from one or more application monitoring appliances.

The reporting server may be accessed by a network engineer to view performance data via a web browser 78. The Performance Reporting Server 74 (PRS) thereby provides a web-based, reporting user-interface that allows users to view the performance statistics and transactions in a web-browser. More than one AMA 60 may be deployed if necessary to sufficiently monitor the desired application transactions.

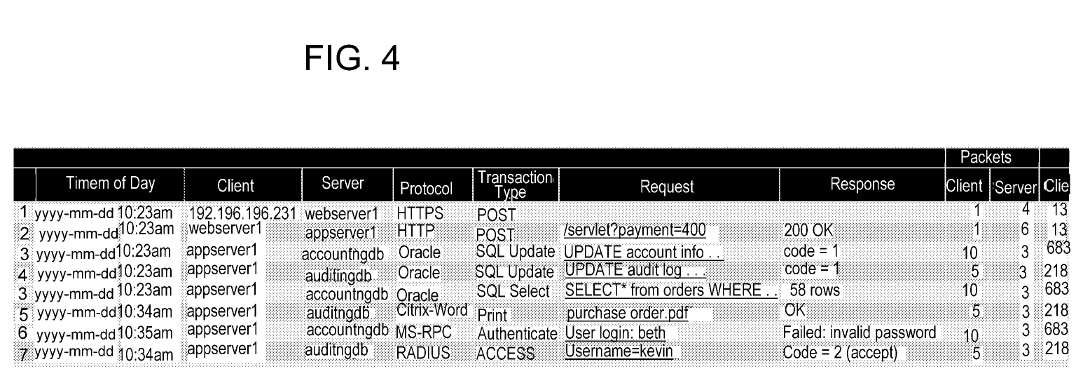

The PRS 74 correlates and aggregates the data from all of the AMAs 60. The PRS 74 allows the user to view the transactions, which may have been collected by multiple AMAs 60 at different observation points, in a time-correlated transaction list. An example transaction list is shown in FIG. 4.

In FIG. 4, 7 example transactions are show listing Time of Day, Client, Server, Protocol, Transaction type, Request, Response, Packets (sub category Client and Server), etc.

Accordingly, the system provides the ability for a network engineer to view transactions in a time sorted list, and to view transaction details, to assist in trouble shooting application problems across all tiers of the n-tier architecture.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method of monitoring network traffic, comprising:
providing an application monitoring appliance to monitor transactions across multiple tiers of an n-tier architecture; and
providing a reporting server for aggregating and correlating monitored data from the application monitoring appliance.

2. The method according to claim 1, further comprising providing access to the reporting server for viewing by a user.

3. The method according to claim 2, wherein said providing access to the reporting server for viewing by a user comprises providing access to report data via a web browser.

4. The method according to claim 1, wherein said multiple tiers comprise tiers selected from the group consisting of application users, web servers, application servers and database servers.

5. The method according to claim 1, further comprising said reporting server providing transaction reports selected from the group consisting of time of day, client information, server information, protocol information, transaction type information, request information, response information, and packet information.

6. The method according to claim 5, wherein said packet information report further comprises information subdivided into client and/or server information categories.

7. The method according to claim 1, further comprising providing plural ones of said application monitoring appliances, wherein ones of said application monitoring appliances are positioned to monitor traffic between different ones of tiers of said n-tier architecture.

8. An apparatus for monitoring n-tier network architecture traffic, comprising:
at least one application monitoring appliance to monitor transactions across multiple tiers of the n-tier network architecture; and
a reporting server for aggregating and correlating monitored data from the application monitoring appliance.

9. The apparatus according to claim 8, further comprising a web-based user interface for providing access to the reporting server for viewing by a user.

10. The apparatus according to claim 9, wherein said web-based interface provides access to report data via a web browser.

11. The apparatus according to claim 8, wherein said multiple tiers comprise tiers selected from the group consisting of application users, web servers, application servers and database servers.

12. The apparatus according to claim 8, further comprising at least a second application monitoring appliance, wherein said at least one application monitoring appliance and said at least a second application monitoring appliance are positioned to monitor traffic between different ones of tiers in said n-tier architecture.

13. The apparatus according to claim 8, wherein said reporting server provides transaction reports selected from the group consisting of time of day, client information, server information, protocol information, transaction type information, request information, response information, and packet information.

14. The apparatus according to claim 13, wherein said packet information report further comprises information subdivided into client and/or server information categories.

15. In an n-tier-tier network architecture, a system for monitoring and reporting network traffic, comprising:
plural application monitoring appliances to monitor transactions across multiple tiers of the n-tier network architecture, ones of said plural application monitoring appliances monitoring traffic between two or more tiers or between a tier and a network user; and
a reporting server for receiving and aggregating and correlating monitored data from the application monitoring appliances.

16. The system according to claim 15, further comprising a web-based user interface for providing access to the reporting server for viewing by a user of the system for monitoring and reporting.

17. The system according to claim 16, wherein said web-based interface provides access to report data via a web browser.

18. The system according to claim 15, wherein said multiple tiers comprise tiers selected from the group consisting of application users, web servers, application servers and database servers.

19. The system according to claim 15, wherein said reporting server provides transaction reports selected from the group consisting of time of day, client information, server information, protocol information, transaction type information, request information, response information, and packet information.

20. The apparatus according to claim 19, wherein said packet information report further comprises information subdivided into client and/or server information categories.
